(19) United States
(12) Patent Application Publication
(10) Pub. No.: US 2025/0094901 A1
(43) Pub. Date: Mar. 20, 2025

(54) Electric Power Material Distribution and Allocation Method Based on Optimized Branch and Bound Method

(71) Applicant: Chuxiong Power Supply Bureau of Yunnan Power Grid Co., Ltd., Chuxiong (CN)

(72) Inventors: Xiao ZHAO, Chuxiong (CN); Baokang WANG, Chuxiong (CN); Jiayong YANG, Chuxiong (CN); Yun ZHANG, Chuxiong (CN); Yunjiang YU, Chuxiong (CN); Can SUN, Chuxiong (CN); Cong ZHU, Chuxiong (CN); Honghao DAI, Chuxiong (CN); Tianji XU, Chuxiong (CN); Zixiang YAN, Chuxiong (CN)

(21) Appl. No.: 18/959,151

(22) Filed: Nov. 25, 2024

Related U.S. Application Data
(63) Continuation of application No. PCT/CN2023/095181, filed on May 19, 2023.

(30) Foreign Application Priority Data
Sep. 20, 2022 (CN) 2022111424647

(51) Int. Cl. G06Q 10/0631; G06Q 10/04; G06Q 10/083; G06Q 50/06

(52) U.S. Cl. CPC G06Q 10/06315; G06Q 10/04; G06Q 10/083; G06Q 50/06

(57) ABSTRACT

The present invention provides an electric power material distribution and allocation method based on an optimized branch and bound method, including: sorting the distribution of each batch of electric power materials to obtain a material set R; screening available vehicle data to obtain a vehicle deadweight set W and a vehicle unique identification set C; determining whether available vehicles meet requirements; and using an optimized queued branch and bound method to obtain an optimal distribution and allocation scheme. According to the present invention, scientific scheme support is provided for the distribution and allocation of the electric power materials, the scientificity of the distribution of power grid materials is improved, the influence of human factors is reduced, the utilization rate of distribution vehicles is increased, the distribution cost of the materials is reduced, and the economic benefit is improved.

### CROSS-REFERENCE TO RELATED APPLICATIONS

The present application claims priority to Chinese Patent Application No. 2022111424647, filed on Sep. 20, 2022, the entire disclosure of which is incorporated herein by reference.

### TECHNICAL FIELD

The present invention relates to the technical field of electric power material allocation, and in particular to an electric power material distribution and allocation method based on an optimized branch and bound method.

### BACKGROUND

Materials are the basic guarantee for the operation of a power system, and logistics distribution and supply directly affect the reliability of power supply. At present, the distribution of electric power materials is manually managed, and the allocation of vehicles mainly depends on the experience of allocation personnel, lacking the support of a scientific allocation method. Limited by the working experience of the allocation personnel, human factors have a great influence and are prone to great difference in the rationality and scientificity of an allocation scheme, resulting in the problems of the waste of vehicles and the increase of the distribution cost. Although in the prior art, some intelligent material distribution methods are disclosed, for example:

China patent CN114648210A discloses an intelligent loading method for war materials. In the method, the target loading quantity of each type of war materials is predetermined; for each type of corresponding target loading quantity of each box of war materials and according to each box of war materials not loaded currently and the determined remaining loading space of the vehicle to be loaded, one box of target war materials with the highest priority that can be loaded in the remaining loading space; according to the volume of the target war materials, a target sub-loading space where the target war materials are loaded is determined in the remaining loading space, it is determined that the target war materials are loaded in the target sub-loading space, and the target loading quantity of this type of war materials is updated, so that the loading sequence of the war materials and the corresponding target sub-loading pace can be determined by an electronic device; and compared with the method for manually determining the loading scheme of war materials the prior art, the degree of intelligence of loading the war materials is increased.

China patent CN113743860A discloses a method and system for loading materials by vehicles, an electronic device and a storage medium, and relates to the field of vehicles. The method for loading materials by vehicles according to the present application includes: obtaining material information of materials to be transported and transport capacity information of current allocatable vehicles, where the material information includes cargo information and distribution information; then obtaining a target vehicle required to be allocated according to the distribution information and the transport capacity information; performing calculation according to the cargo information and the obtained target vehicle to obtain a loading scheme of the materials to be transported; and finally, loading the material to be transported into the corresponding target vehicle based on the loading scheme. According to embodiments of the present application, the distribution information and the transport capacity information are combined, the target vehicle required to be allocated is obtained first, then the materials are loaded in the target vehicles according to the designed loading scheme, and the loading efficiency of the materials can be improved by designing a reasonable loading scheme before material loading.

China patent CN113743874A discloses an optimized dispatching method for emergency material logistics distribution. Firstly, the problem is decomposed into a vehicle path sub-problem of a single vehicle with a packing constraint by a cutting method, a mixed whale optimization algorithm based on a three-dimensional matrix updating strategy is designed to reasonably plan the distribution path of the sub-problem, and a packing strategy based on skyline filling is proposed to solve the packing problem. When the emergency materials required by a next customer cannot be fully loaded in the vehicle, a vehicle will be re-dispatched for loading until all the emergency materials are fully loaded, and a vehicle distribution path and a packing scheme thereof are formulated before the vehicle leaves. According to the present invention, the emergency materials can be rapidly loaded into a carriage in a shorter time and sent to the position of the customer in time, so that the distribution efficiency of the emergency materials can be improved, the logistics cost can be reduced, an emergency management strategy can be enriched, and reference can be provided for the scientific management and decision making of large-scale emergencies.

These disclosed intelligent distribution method for materials have the own advantages, but the methods cannot be suitable for the distribution and allocation of electric power materials. The distribution of the electric power materials has the characteristics that the materials have numerous categories, a large number of overlapping small materials are present, the loading capacity is mainly limited by weight, and the types of the transport vehicles are numerous and non-uniform. While according to an intelligent loading material for war materials in the existing disclosed method CN114648210A, it is necessary to obtain the maximum deadweight and the loading space of a vehicle to be loaded, the unit weight and unit volume of all war materials in the vehicle to be loaded are determined according to the loading ratio of each type of war materials preset by the vehicle to be loaded and the weight and volume of one box of war materials in each type, the minimum value of the loading quantity is determined according to the maximum deadweight, the unit weight, the loading space and the unit volume, and the target loading quantity of each type of war materials is determined according to the minimum value, and the loading ratio and the preset loading quantity of each type of war materials; in the method for loading materials by vehicles in CN113743860A, it is necessary to obtain an empty loading space of the target vehicle in which materials to be transported are not loaded and match the materials to be transported with the smallest difference from the size of the empty loading space and load the materials to be transported to the empty loading space; and CN113743874A adopts a packing strategy based on skyline filling, it is necessary to obtain the bottom area and height of the materials and carriage space data, emergency materials are put into each position parallel with the bottom of the carriage in the skyline for comparison, and an appropriate position is finally determined. In these methods, it is necessary to calculate the space. Due to the characteristics of the electric power materials, it is necessary to supplement and enter a large amount of space-related data in the early stage, so that the entry workload is greatly increased. Furthermore, when these space calculation methods are applied to small overlapping materials, space will be wasted, and the distribution cost of the electric power materials can be increased.

Therefore, it is necessary to invent a method suitable for the distribution and allocation of the electric power materials so as to be better suitable for the distribution characteristics of the electric power materials. Before material loading, a reasonable loading scheme can be rapidly obtained by the method, and the current situation that the distribution and allocation of the electric power materials mainly depend on personnel experience and the human factors have great influence is changed, thereby providing scientific scheme support for the distribution and allocation of the electric power materials, reducing the influence of the human factors, increasing the utilization rate of the vehicles, and reducing the distribution cost of the materials.

### SUMMARY

In view of this, the present invention mainly provides an electric power material distribution and allocation method based on an optimized branch and bound method. According to the method, an optimal electric power material distribution and allocation scheme is obtained by an optimized branch and bound method according to the electric power material distribution requirement, so that scientific scheme support is provided for the distribution and allocation of the electric power materials, the scientificity of the distribution of power grid materials is improved, the influence of human factors is reduced, the utilization rate of distribution vehicles is increased, the distribution cost of the materials is reduced, and the economic benefit is improved.

To achieve the inventive objective of the present application, the present application adopts the following technical solutions:
an electric power material distribution and allocation method based on an optimized branch and bound method according to the present invention includes the following steps:

### (I). Sorting the Distribution of Each Batch of Electric Power Materials to Obtain a Material Set R

obtaining electric power material distribution demand data, wherein the data comprises a quantity n of electric power materials to be distributed and a material weight; and performing sorting according to the above material weight so as to enable Rᵢ>Rᵢ₊₁, obtain a material weight set R={R₁, R₂, R₃, . . . , Rₙ} and obtain Rₘᵢₙ and

$${\sum }_{i = 1}^{n} {R}_{i} ,$$

wherein Rₘᵢₙ is Rₙ, and

$${\sum }_{i = 1}^{n} {R}_{i} = \{ {R}_{1} + {R}_{2} + {R}_{3} + … + {R}_{n} \} ;$$

### (II). Screening Available Vehicle Data to Obtain a Vehicle Deadweight Set W and a Vehicle Unique Identification Set C

obtaining available vehicle data according to the demand of the electric power materials; performing sorting according to a rule that the deadweight Wᵢ of each vehicle is greater than or equal to Wᵢ₊₁; screening vehicles according to the condition that

$${R}_{min} ⩽ {W}_{j} ⩽ {\sum }_{i = 1}^{n} {R}_{i} ;$$

assuming that there are m available vehicles before screening, obtaining a deadweight set W of the available vehicles after screening and a corresponding vehicle unique identification set C, wherein the deadweight set W={W₁, W₂, W₃, . . . , Wₙ}, and the vehicle unique identification set C={C₁, C₂, C₃, . . . , Cₙ}; and obtaining

$${\sum }_{j = 1}^{m} {W}_{j} ;$$

### (III). Determining Whether Available Vehicles Meet Requirements

when

$${\sum }_{i = 1}^{n} {R}_{i} ⩽ {\sum }_{j = 1}^{m} {W}_{j} ,$$

performing a subsequent step s (IV) for calculation;
when

$${\sum }_{i = 1}^{n} {R}_{i} > {\sum }_{j = 1}^{m} {W}_{j} ,$$

searching for a vehicle with a minimum deadweight of

$$W ⩾ {\sum }_{i = 1}^{n} {R}_{i} ,$$

and loading all the materials into the vehicle; and
when

$${\sum }_{i = 1}^{n} {R}_{i} > {\sum }_{j = 1}^{m} {W}_{j}$$

and the vehicle of

$$W ⩾ {\sum }_{i = 1}^{n} {R}_{i}$$

is not found in the vehicles before screening, determining that there is no distribution scheme meeting the requirements, requiring a user to split the electric power materials, then transporting the materials in batches, and returning to the step (I) to respectively distribute each batch of materials; and

### (IV). Using an Optimized Queued Branch and Bound Method to Obtain an Optimal Distribution and Allocation Scheme.

In the electric power material distribution and allocation method based on an optimized branch and bound method according to the present invention, using an optimized queued branch and bound method includes the following steps:

### (A). Constructing a Primary Layer of Nodes

in the primary layer of nodes, recording Eᵣ₀, w₀, Rᵣ₀, Q₀ and X₀, wherein Eᵣ₀ represents a total weight of materials to be loaded, w₀ represents a total deadweight of a truck, Rᵣ₀ represents a material weight set, Q₀ represents a total wasted deadweight which is set to 0, X₀ is a hierarchical sequence, and X₀ is an empty set and records the state and deadweight of the vehicle in use;
   (B). Constructing a p^{th} Layer of Nodes and Setting p=1
respectively constructing the p^{th} layer of nodes at lower ends of left and right sides of the primary layer of nodes or each upper layer of nodes, where the node on the left side represents a p^{th} vehicle using the vehicle unique identification set C to load materials; in the node on the left, loading the materials in the set Rᵣ₍ₚ₋₁₎ of the weights of the remaining materials of the upper layer of nodes into the p^{th} vehicle of the vehicle deadweight set W as much as possible, and after loading, recording Eᵣₚ, wₚ, Rᵣₚ, Qₚ and Xₚ in the node, where Eᵣₚ represents the total weight of the remaining materials to be loaded of the node, wₚ represents the total remaining truck deadweight of the node, wₚ W₍ₚ₋₁₎−Wₚ, Wₚ is the deadweight of the p^{th} vehicle, Rᵣₚ represents the set of the weights of the remaining materials of the node, Qₚ represents the total wasted deadweight of the node, Qₚ-Q₍ₚ₋₁₎+Wₚ−(the weight of the materials actually loaded on the p^{th} vehicle), and Xₚ is the hierarchical sequence of the node; recording the vehicle unique identification of the used vehicle and the weight of the loaded materials in the hierarchical sequence Xₚ in sequence; in the node on the right, indicating that the p^{th} vehicle is not used to load the materials; and in the node on the right side, recording Eᵣₚ, wₚ, Rᵣₚ, Qₚ and Xₚ, where Eᵣₚ represents the total weight of the remaining materials to be loaded of the node, Eᵣₚ=Eᵣ₍ₚ₋₁₎, wₚ represents the total remaining truck deadweight of the node, wₚw₍ₚ₋₁₎−Wₚ, Wₚ is the deadweight of the p^{th} vehicle, Rᵣₚ represents the set of the weights of the remaining materials of the node, Rᵣₚ=Rᵣ₍ₚ₋₁₎, Qₚ represents the total wasted deadweight of the node, Qₚ=Q₍ₚ₋₁₎, Xₚ is the hierarchical sequence of the node, and Xₚ−X₍ₚ₋₁₎; and
   (C). Constructing a (p=p+1)^{th} Layer of Nodes

assuming that p=p+1, repeating the step (B) according to the node on the left side and the node on the right side of each node; when Eᵣ>w or Eᵣ=0 in the node, stopping the calculation of the subsequent nodes, otherwise, continuing the calculation of the lower layer of nodes until constructing p=m hierarchy, where m is the quantity of the available vehicles; finally finding a node of Eᵣ=0, finding Q values of the nodes, comparing the Q values of the node, and finding the node with the minimum Q value and the hierarchical sequence X thereof, where the vehicle allocation of the node is an optimal distribution and allocation scheme, and the hierarchical sequence X thereof is the used vehicle unique identification and the corresponding weight of each loaded material; and when the node of Eᵣ=0 is n found, returning to the step (IIII), and processing according to the second or third case.

In the electric power material distribution and allocation method based on an optimized branch and bound method according to the present invention, placing the materials in the set Rᵣ₍ₚ₋₁₎ of the weights of the remaining materials of the (p−1)^{th} layer of nodes into the p^{th} vehicle of the vehicle deadweight set W as much as possible includes the following steps: comparing the deadweight Wₚ of the p^{th} vehicle and the first material weight of the set Rᵣ₍ₚ₋₁₎ of the weights of the remaining materials of the upper layer; when the deadweight Wₚ of the p^{th} truck is less than the first material weight of the set Rᵣ of the weights of the remaining materials of the upper layer, stopping the calculation of the node and the subsequent nodes; when the deadweight Wₚ of the p^{th} truck is greater than the first material weight of the set Rᵣ of the weights of the remaining materials of the upper layer, putting the first material of the set Rᵣ₍ₚ₋₁₎ of the weights of the remaining materials of the upper layer into the p^{th} truck, re-calculating the remaining deadweight of the p^{th} truck and the set of the weights of the remaining materials, sequentially traversing the material weight in the set of the weights of the remaining materials, and putting the materials in the set of the weights of the remaining materials into the p^{th} truck in an order from heavy to light until the lightest materials in the set Rᵣ₍ₚ₋₁₎ of the weights of the remaining materials is not capable of being put into the remaining deadweight of the p^{th} truck or the materials of the set Rᵣ₍ₚ₋₁₎ of the weights of the remaining materials is put into the p^{th} truck.

In the electric power material distribution and allocation method based on an optimized branch and bound method according to the present invention, the node has one corresponding upper-layer node and two corresponding lower-layer nodes.

In the electric power material distribution and allocation method based on an optimized branch and bound method according to the present invention, the node of Eᵣ>w or Eᵣ=0 has no corresponding lower-layer node.

In the electric power material distribution and allocation method based on an optimized branch and bound method according to the present invention, when the deadweight Wₚ of the p^{th} truck is less than the first material weight of the set Rᵣ of the weights of the remaining materials of the upper layer, and the node has no corresponding lower-layer node.

In the electric power material distribution and allocation method based on an optimized branch and bound method according to the present invention, the total remaining truck deadweights wₚ among each layer of nodes are the same.

### The Present Invention has the Following Beneficial Effects:

In the present invention, electric power material distribution demand data are obtained and sorted according to the electric power materials; the available vehicle data of the available vehicles is obtained according to the demand of the electric power materials, the vehicle data is sorted, and the vehicle data is screened according to a screening rule; it is determined whether the available vehicles meet the requirements, and different processing is performed according to the situations; and the optimized queued branch and bound method is used to obtain the optimal distribution and allocation scheme. According to the present invention, scientific scheme support is provided for the distribution and allocation of the electric power materials, the scientificity of the distribution of power grid materials is improved, the influence of human factors is reduced, the utilization rate of distribution vehicles is increased, the distribution cost of the materials is reduced, and the economic benefit is improved.

### BRIEF DESCRIPTION OF DRAWINGS

FIG. 1 is a flowchart of a method according to an embodiment of the present invention; and

FIG. 2 is a diagram of a calculation process of using an optimized queued branch and bound method according to an embodiment of the present invention.

### DETAILED DESCRIPTION OF THE EMBODIMENTS

For making objectives, technical solutions and advantages of the present invention clearer, the present invention will be further described in detail below with reference to the specific embodiments and the accompanying drawings. It should be understood that these descriptions are exemplary only, and are not intended to limit the scope of the present invention. In addition, in the following description, descriptions of well-known structures and techniques are omitted to avoid unnecessarily obscuring the concepts of the present invention.

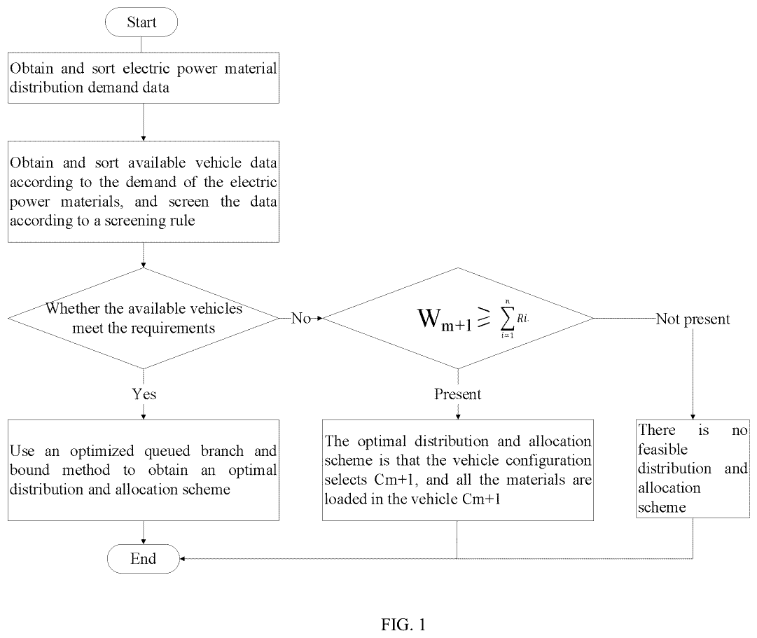

As shown in FIG. 1, an electric power material distribution and allocation method based on an optimized branch and bound method according to the present invention includes the following steps:

### (I). Sorting the Distribution of Each Batch of Electric Power Materials to Obtain a Material Set R

As shown in Table 1, electric power material distribution demand data is obtained, where the data includes a quantity n of electric power materials to be distributed and a material weight; sorting is performed according to the above material weight so as to enable Rᵢ>Rᵢ₊₁, obtain a material weight set R={1000, 800, 800, 500, 100, 100} and obtain Rₘᵢₙ and

$${\sum }_{i = 1}^{n} {R}_{i} ,$$

where Rₘᵢₙ is Rₙ=100, and

$${\sum }_{i = 1}^{n} {R}_{i} = \{ {R}_{1} + {R}_{2} + {R}_{3} + … + {R}_{n} \} = 3300 .$$

TABLE 1

| Material Name | Quantity | Unit Weight |
|---|---|---|
| Material 1 | 1 | 1000 |
| Material 2 | 2 | 800 |
| Material 3 | 1 | 500 |
| Material 4 | 2 | 100 |

### (II). Screening Available Vehicle Data to Obtain a Vehicle Deadweight Set W and a Vehicle Unique Identification Set C

As shown in Table 2, available vehicle data is obtained according to the demand of the electric power materials; sorting is performed according to a rule that the deadweight Wᵢ of each vehicle is greater than or equal to Wᵢ₊₁; vehicles are screened according to the condition that

$${R}_{min} ⩽ {W}_{j} ⩽ {\sum }_{i = 1}^{n} {R}_{i} ;$$

assuming that there are m available vehicles after screening, a deadweight set W of the available vehicles before screening and a corresponding vehicle unique identification set C are obtained, where the deadweight set W={2350, 2145, 995, 500}, and the vehicle unique identification set C={C1, C2, C3, C4}; and

$${\sum }_{j = 1}^{m} {W}_{j} = 5990$$

can be obtained.

TABLE 2

| | Vehicle Unique | |
|---|---|---|
| Vehicle | Identification | Deadweight (kg) |
| Vehicle 1 | C1 | 2350 |
| Vehicle 2 | C2 | 2145 |
| Vehicle 3 | C3 | 995 |
| Vehicle 4 | C4 | 500 |
| Vehicle 5 | C5 | 3500 |

### (III). Determining Whether Available Vehicles Meet Requirements

when

$${\sum }_{i = 1}^{n} {R}_{i} \leq {\sum }_{j = 1}^{m} {W}_{j} ,$$

performing a subsequent step (IV) for calculation;
when

$${\sum }_{i = 1}^{n} {R}_{i} > {\sum }_{j = 1}^{m} {W}_{j} ,$$

searching for a vehicle with a minimum deadweight of

$$W \geq {\sum }_{i = 1}^{n} {R}_{i} ,$$

and loading all the materials into the vehicle; and
when

$${\sum }_{i = 1}^{n} {R}_{i} > {\sum }_{j = 1}^{m} {W}_{j}$$

and the vehicle of

$$W \geq {\sum }_{i = 1}^{n} {R}_{i}$$

is not found in the vehicles before screening, determining that there is no distribution scheme meeting the requirements, requiring a user to split the electric power materials, then transporting the materials in batches, and returning to the step (I) to respectively distribute each batch of materials; and
(IV). An Optimal Distribution and Allocation Scheme is Obtained According to an Optimized Queued Branch and Bound Method. The Method Includes the Following Steps:

### (A). Constructing a Primary Layer of Nodes

In the primary layer of nodes, Eᵣ₀, w₀, Rᵣ₀, Q₀ and X₀ are recorded, where Eᵣ₀ represents a total weight of materials to be loaded, Eᵣ₀=3300; w₀ represents a total deadweight of a truck and w₀=5990, Rᵣ₀ represents a material weight set and Rᵣ₀={1000, 800, 800, 500, 100, 100}, Q₀ represents a total wasted deadweight which is set to 0, X₀ is a hierarchical sequence, and X₀ is an empty set, X₀={ }, and records the state and deadweight of the vehicle in use.

(B). Construct the First of Nodes and Set p=1

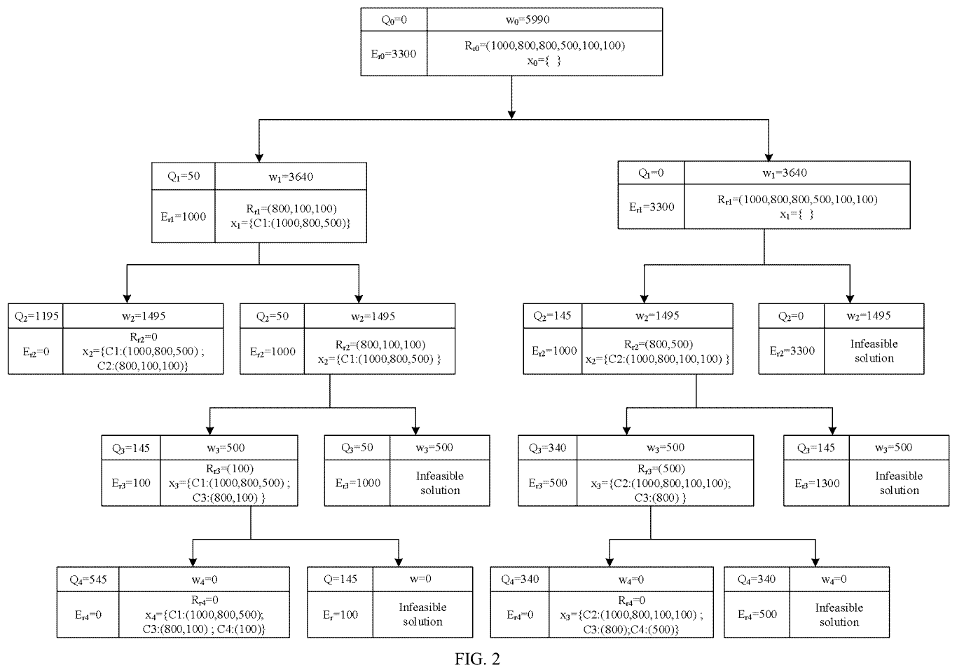

As shown in FIG. 2, the p^{th} layer of nodes are respectively constructed at lower ends of left and right sides of the primary layer of nodes or each upper layer of nodes, where the node on the left side represents a first vehicle using the vehicle unique identification set C to load materials; in the node on the left, the materials in the set Rᵣ₀ of the weights of the remaining materials of the upper layer of nodes into the first vehicle of the vehicle deadweight set W as much as possible; materials 1000, 800 and 500 are put in the first vehicle; after loading, Eᵣ₁, w₁, Rᵣ₁, Q₁ and X₁ are recorded in the node, where Eᵣ₁ represents the total weight of the remaining materials to be loaded of the node and Eᵣ₁=3300−2300=1000, w₁ represents the total remaining truck deadweight of the node, w₁=5990−2350=3640, 2350 is the deadweight of the first vehicle, Rᵣ₁ represents the set of the weights of the remaining materials of the node and Rᵣ₁={800, 100, 100} and Q₁=0+2350−(1000+800+500)=50, and X₁ is the hierarchical sequence of the node; the vehicle unique identification of the used vehicle and the weight of the loaded materials are recorded in the hierarchical sequence X₁ in sequence, X₁={C1: (1000, 800, 500)}; in the node on the right, it is indicated that the first vehicle is not used to load the materials; and in the node on the right side, Eᵣ₁, w₁, Rᵣ₁, Q₁ and X₁ are recorded, where Eᵣ₁c represents the total weight of the remaining materials to be loaded of the node, Eᵣ₁=Eᵣ₀=3300, w₁ represents the total remaining truck deadweight of the node, w₁=5990−2350=3640, Rᵣ₁ represents the set of the weights of the remaining materials of the node, Rᵣ₁=Rᵣ₀, Rᵣ₁={1000, 800, 800, 500, 100, 100}, Q₁ represents the total wasted deadweight of the node, Q₁=Q₀=0, X₁ is the hierarchical sequence of the node, and X₁=X₀, and X₁={ }.

Placing the materials in the set R₀ of the weights of the remaining materials of the primary layer of nodes into the first vehicle of the vehicle deadweight set W as much as possible includes the following steps: the deadweight W₁=2350 of the first vehicle is compared with the first material weight 1000 of the set R₀ of the weights of the remaining materials of the primary layer; when the deadweight W₁ of the first truck is less than the first material weight of the set R₀ of the weights of the remaining materials of the primary layer, the calculation of the node and the subsequent nodes is stopped; when the deadweight W₁ of the first truck is greater than the first material weight of the set R₀ of the weights of the remaining materials of the primary layer, the first material of the set R₀ of the weights of the remaining materials of the primary layer is put into the first truck, the remaining deadweight 2350−1000=1350 of the first truck and the set {800, 800, 500, 100, 100} of the weights of the remaining materials are re-calculated, the material weight in the set of the weights of the remaining materials is sequentially traversed, and the materials in the set of the weights of the remaining materials are put into the first truck in an order from heavy to light, and 800 and 500 are put into the first truck until the lightest materials 100 in the set R₀ of the weights of the remaining materials cannot be put into the remaining deadweight 50 of the first truck.

### (C). Construct a Second Layer of Nodes

P=1+1=2 is set, the node on the left side of the lower layer of the first layer of nodes is taken as an example, and the step (B) is repeated, where the node on the left side represents a second vehicle using the vehicle unique identification set C to load materials; in the node on the left, the materials in the set Ru of the weights of the remaining materials of the first layer of nodes are loaded into the second vehicle of the vehicle deadweight set W as much as possible; materials 800, 100 and 100 are put in the second vehicle; after loading, Eᵣ₂, w₂, Rᵣ₂, Q₂ and X₂ are recorded in the node, where Eᵣ₂ represents the total weight of the remaining materials to be loaded of the node and Eᵣ₂=0, w₂ represents the total remaining truck deadweight of the node, w₂=3640−2145=1495, 2145 is the deadweight of the second vehicle, Rᵣ₂ represents the set of the weights of the remaining materials of the node and Rᵣ₂={ }, Q₂ represents the total wasted deadweight of the node, Q₂=50+2145−1000=1195, X₂ is the hierarchical sequence of the node; the vehicle unique identification of the used vehicle and the weight of the loaded materials are recorded in the hierarchical sequence X₂ in sequence X₂={C1: (1000, 800, 500), C2: (800, 100, 100)}; in the node on the right, it is indicated that the first vehicle is not used to load the materials; and in the node on the right side, Eᵣ₂, w₂, Rᵣ₂, Q₂ and X₂ are recorded, where Eᵣ₂ represents the total weight of the remaining materials to be loaded of the node, Eᵣ₂=1000, w₂ represents the total remaining truck deadweight of the node, w₂=3640−2145=1495, Rᵣ₂ represents the set of the weights of the remaining materials of the node, Rᵣ₂=Rᵣ₁, Rᵣ₂={800, 100, 100c}, Q₂ represents the total wasted deadweight of the node, Q₂=Q₁=50, X₂ is the hierarchical sequence of the node, and X₂={C1: (1000, 800, 500)}.

In the node on the left, Eᵣ₂=0, and the calculation of the subsequent nodes is stopped; the node on the right side continues the calculation of the lower layer of nodes; the above step is repeated; as shown in FIG. 2, at the node on the right side of the third layer of nodes, Eᵣ₃>w₃, and the calculation of the subsequent nodes is stopped; and the node on the left side of the third layer of nodes continues the calculation until p=4 hierarchy is constructed, where 4 is the quantity of the available vehicles. After all the calculation is completed, the nodes of Eᵣ=0 are finally found, and include the hierarchical sequences and Q values of the following three nodes:
X₂={C1: (1000, 800, 500), C2: (800, 100, 100)}, Q₂=1195;
X₄={C1: (1000, 800, 500), C3: (800, 100), C4: (100)}, Q₄=545; and
X₄={C2: (1000, 800, 100), C3: (800), C4: (500)}, Q₄=340.

The Q values of the above nodes are compared, and the node with the minimum Q value and the hierarchical sequence X thereof are found, where X₄={C2: (1000, 800, 100), C3: (800), C4: (500)} and Q₄=340; the vehicle allocation of the node is the optimal distribution and allocation scheme, that is, goods with the weight of (1000, 800, 100) are transported by the vehicle C2, goods with the weight of (800) are transported by the vehicle C3, and goods with the weight of (500) are transported by the vehicle C4; the goods are transported by the above three vehicles, so that the total wasted deadweight can be minimized; and when the nodes of Eᵣ=0 are not found, the step (III) is returned, an processing is performed according to the second or third case.

It should be particularly noted that p represents the hierarchy, and in the same hierarchy, Eᵣₚ, wₚ, Rᵣₚ and Qₚ among each node are different. They are all marked as Eᵣₚ in different nodes in the same hierarchy, but Eᵣₚ among different nodes are different. Similarly, in different nodes in the same hierarchy, wₚ, Rᵣₚ and Qₚ are also different. In the Q values compared above, the subscript of Q is ignored.

It should be understood that the foregoing specific embodiments of the present invention are only used to illustrate or explain the principle of the present invention, but not to limit the present invention. Therefore, any modifications, equivalent substitutions, improvements, and the like made without deviating from the spirit and scope of the present invention shall fall within the scope of protection of the present invention. Moreover, the appended claims of the present invention are intended to cover all variations and modifications falling within the scope and boundary of the appended claims or within equivalent forms of the scope and boundary.

What is claimed is:

1. An electric power material distribution and allocation method based on an optimized branch and bound method, comprising the following steps:
(I). sorting the distribution of each batch of electric power materials to obtain a material set R
obtaining electric power material distribution demand data, wherein the data comprises a quantity n of electric power materials to be distributed and a material weight; and performing sorting according to the above material weight so as to enable Rᵢ≥Rᵢ₊₁, obtain a material weight set R={R₁, R₂, R₃, . . . , Rₙ} and obtain Rₘᵢₙ and
$${\sum }_{i = 1}^{n} {R}_{i} ,$$
wherein Rₘᵢₙ is Rₙ, and
$${\sum }_{i = 1}^{n} {R}_{i} = \{ {R}_{1} + {R}_{2} + {R}_{3} + … + {R}_{n} \} ;$$
(II). screening available vehicle data to obtain a vehicle deadweight set W and a vehicle unique identification set C
obtaining available vehicle data according to the demand of the electric power materials; performing sorting according to a rule that the deadweight Wᵢ of each vehicle is greater than or equal to Wᵢ₊₁; screening vehicles according to the condition that
$${R}_{min} \leq {W}_{j} \leq {\sum }_{i = 1}^{n} {R}_{i} ;$$
assuming that there are m available vehicles before screening, obtaining a deadweight set W of the available vehicles after screening and a corresponding vehicle unique identification set C, wherein the deadweight set W={W₁, W₂, W₃, . . . , Wₙ}, and the vehicle unique identification set C={C₁, C₂, C₃, . . . , Cₙ}; and obtaining
$${\sum }_{j = 1}^{m} {W}_{j} ;$$
(III). determining whether available vehicles meet requirements when
$${\sum }_{i = 1}^{n} {R}_{i} \leq {\sum }_{j = 1}^{m} {W}_{j} ,$$
performing a subsequent step (IV) for calculation;
when
$${\sum }_{i = 1}^{n} {R}_{i} > {\sum }_{j = 1}^{m} {W}_{j} ,$$
searching for a vehicle with a minimum deadweight of
$$W \geq {\sum }_{i = 1}^{n} {R}_{i} ,$$
and loading all the materials into the vehicle; and
when
$${\sum }_{i = 1}^{n} {R}_{i} > {\sum }_{j = 1}^{m} {W}_{j}$$
and the vehicle of
$$W \geq {\sum }_{i = 1}^{n} {R}_{i}$$
is not found in the vehicles before screening, determining that there is no distribution scheme meeting the requirements, requiring a user to split the electric power materials, then transporting the materials in batches, and returning to the step (I) to respectively distribute each batch of materials; and
(IV). using an optimized queued branch and bound method to obtain an optimal distribution and allocation scheme.

2. The electric power material distribution and allocation method based on an optimized branch and bound method according to claim 1, wherein using an optimized queued branch and bound method comprising the following steps:
(A). constructing a primary layer of nodes
in the primary layer of nodes, recording Eᵣ₀, w₀, Rᵣ₀, Q₀ and X₀, wherein Eᵣ₀ represents a total weight of materials to be loaded, w₀ represents a total deadweight of a truck, Rᵣ₀ represents a material weight set, Q₀ represents a total wasted deadweight which is set to 0, X₀ is a hierarchical sequence, and X₀ is an empty set and records the state and deadweight of the vehicle in use;
(B). constructing a p^{th} layer of nodes and setting p=1
respectively constructing the p^{th} layer of nodes at lower ends of left and right sides of the primary layer of nodes or each upper layer of nodes, wherein the node on the left side represents a p^{th} vehicle using the vehicle unique identification set C to load materials; in the node on the left, loading the materials in the set Rᵣ₍ₚ₋₁₎ of the weights of the remaining materials of the upper layer of nodes into the p^{th} vehicle of the vehicle deadweight set W as much as possible, and after loading, recording Eᵣₚ, wₚ, Rᵣₚ, Qₚ and Xₚ in the node, wherein Eᵣₚ represents the total weight of the remaining materials to be loaded of the node, wₚ represents the total remaining truck deadweight of the node, wₚ=w₍ₚ₋₁₎−Wₚ, Wₚ is the deadweight of the p^{th} vehicle, Rᵣₚ represents the set of the weights of the remaining materials of the node, Qₚ represents the total wasted deadweight of the node, Qₚ=Q₍ₚ₋₁₎+Wₚ−(the weight of the materials actually loaded on the p^{th} vehicle), and Xₚ is the hierarchical sequence of the node; recording the vehicle unique identification of the used vehicle and the weight of the loaded materials in the hierarchical sequence Xₚ in sequence; in the node on the right, indicating that the p^{th} vehicle is not used to load the materials; and in the node on the right side, recording Eᵣₚ, wₚ, Rᵣₚ, Qₚ and Xₚ, wherein Eᵣₚ represents the total weight of the remaining materials to be loaded of the node, Eᵣₚ=Eᵣ₍ₚ₋₁₎, wₚ represents the total remaining truck deadweight of the node, wₚ=w₍ₚ₋₁₎−Wₚ, Wₚ is the deadweight of the p^{th} vehicle, Rᵣₚ represents the set of the weights of the remaining materials of the node, Rᵣₚ=Rᵣ₍ₚ₋₁₎, Qₚ represents the total wasted deadweight of the node, Qₚ=Q₍ₚ₋₁₎, Xₚ is the hierarchical sequence of the node, and Xₚ=X₍ₚ₋₁₎; and
(C) constructing a (p=p+1)^{th} layer of nodes
assuming that p=p+1, repeating the step (B) according to the node on the left side and the node on the right side of each node; when Eᵣ>w or Eᵣ=0 in the node, stopping the calculation of the subsequent nodes, otherwise, continuing the calculation of the lower layer of nodes until constructing p=m hierarchy, wherein m is the quantity of the available vehicles; finally finding a node of Eᵣ=0, finding Q values of the nodes, comparing the Q values of the node, and finding the node with the minimum Q value and the hierarchical sequence X thereof, wherein the vehicle allocation of the node is an optimal distribution and allocation scheme, and the hierarchical sequence X thereof is the used vehicle unique identification and the corresponding weight of each loaded material; and when the node of Eᵣ=0 is n found, returning to the step (IIII), and processing according to the second or third case.

3. The electric power material distribution and allocation method based on an optimized branch and bound method according to claim 2, wherein placing the materials in the set Rᵣ₍ₚ₋₁₎ of the weights of the remaining materials of the (p−1)^{th} layer of nodes into the p^{th} vehicle of the vehicle deadweight set W as much as possible comprises the following steps: comparing the deadweight Wₚ of the p^{th} vehicle and the first material weight of the set Rᵣ₍ₚ₋₁₎ of the weights of the remaining materials of the upper layer; when the deadweight Wₚ of the p^{th} truck is less than the first material weight of the set Rᵣ of the weights of the remaining materials of the upper layer, stopping the calculation of the node and the subsequent nodes; when the deadweight Wₚ of the p^{th} truck is greater than the first material weight of the set Rᵣ of the weights of the remaining materials of the upper layer, putting the first material of the set Rᵣ₍ₚ₋₁₎ of the weights of the remaining materials of the upper layer into the p^{th} truck, re-calculating the remaining deadweight of the p^{th} truck and the set of the weights of the remaining materials, sequentially traversing the material weight in the set of the weights of the remaining materials, and putting the materials in the set of the weights of the remaining materials into the p^{th} truck in an order from heavy to light until the lightest materials in the set Rᵣ₍ₚ₋₁₎ of the weights of the remaining materials is not capable of being put into the remaining deadweight of the p^{th} truck or the materials of the set Rᵣ₍ₚ₋₁₎ of the weights of the remaining materials is put into the p^{th} truck.

4. The electric power material distribution and allocation method based on an optimized branch and bound method according to claim 3, wherein the node has one corresponding upper-layer node and two corresponding lower-layer nodes.

5. The electric power material distribution and allocation method based on an optimized branch and bound method according to claim 4, wherein the node of Eᵣ>w or Eᵣ=0 has no corresponding lower-layer node.

6. The electric power material distribution and allocation method based on an optimized branch and bound method according to claim 4, wherein when the deadweight Wₚ of the p^{th} truck is less than the first material weight of the set Rᵣ of the weights of the remaining materials of the upper layer, and the node has no corresponding lower-layer node.

7. The electric power material distribution and allocation method based on an optimized branch and bound method according to claim 6, wherein the total remaining truck deadweights wₚ among each layer of nodes are the same.
